(19) United States
(12) Patent Application Publication
(10) Pub. No.: US 2017/0243255 A1
(43) Pub. Date: Aug. 24, 2017

(54) SYSTEM AND METHOD FOR GENERATING, DELIVERING, MEASURING, AND MANAGING MEDIA APPS TO SHOWCASE VIDEOS, DOCUMENTS, BLOGS, AND SLIDES USING A WEB-BASED PORTAL

(71) Applicant: ON24, Inc., San Francisco, CA (US)

(72) Inventor: Jayesh SAHASI, Los Altos, CA (US)

(21) Appl. No.: 15/051,486

(22) Filed: Feb. 23, 2016

(51) Int. Cl. G06Q 30/02; G06F 17/21

(52) U.S. Cl. CPC G06Q 30/0271; G06Q 30/0277; G06F 17/212

(57) ABSTRACT

A system and method for content management are disclosed. The system can be used to manage any type of digital and a system and method for generating, delivering, measuring, and managing media apps to showcase content, such as videos, documents, blogs, and slides, using a web-based portal are provided.

### FIELD

The disclosure relates to the field of marketing—where continuous generation and dissemination of content in various online formats is critical to the engagement of prospects—and this falls within the heading of content creation and content marketing.

### BACKGROUND

All marketing departments use webinars to reach prospects and educate them—whether by doing thought-leadership pieces, or product demonstrations, or various other communication targets. The marketing is intended to move the buyer along in their “journey” to buying a product the marketer is eventually trying to sell. These webinars are powerful communication tools, but there is also a compelling need in marketing for smaller, “snackable” content in various other formats, not just a webinar format.

The problem is a lack of any tools that combine the capabilities for generating, delivering, measuring, and managing media applications (“apps”) to showcase videos, documents, blogs, and slides (collectively “content”) using a web-based portal. Desirably, the content can be uploaded to the portal, or generated from related collateral originally created for a webinar. None of the existing tools, for example, can automatically extract text from Powerpoint files, or automatically perform speech-to-text transcription for the videos—both steps critical to the marketer trying to expose the content to search engines and allowing better, deeper search results.

Tools exist to create a video portal and they nearly always start with someone having to upload a video file. There are also separate tools to upload a document to an online portal. Some portals may even combine documents and videos into one delivery or management interface. There also are separate tools to manage the writing or delivery of online blogs and separate tools where a user can upload a slide deck (e.g., slideshare). However, apart from being different platforms to handle each of these discrete tasks, leading to a lot of wasted time in learning how to use them, there isn't a mechanism for centrally managing all of this content.

Since there is no single central tool to manage these different types of content, all of the existing solutions require different management interfaces and completely different, unrelated software systems to be put into place. This makes using and managing these systems very difficult, even though it is possible to cobble together a capability that looks from the outside to have the ability to handle many of the same assets and pieces of collateral. Because they existing systems are different systems, it is not possible to have a set of uniform reports across all of them. Furthermore, none of the existing solutions have the capability to extract all these various pieces of collateral from an existing webinar, in addition to allowing the raw content to be uploaded.

### BRIEF DESCRIPTION OF THE DRAWINGS

FIG. 1 illustrates an example of a content management system;

FIG. 2 illustrates more details of the media portal system;

FIGS. 3 and 4 illustrate a content system that incorporates the media portal system;

FIG. 5 illustrates an example of a video media app of the media portal system;

FIGS. 6 and 7 illustrate an example of a document media app of the media portal system;

FIGS. 8-9 illustrate more details of the video media app that is part of the media portal system; and

FIG. 10 illustrates a content management interface of the media portal system.

### DETAILED DESCRIPTION OF ONE OR MORE EMBODIMENTS

The disclosure is particularly applicable to the different types of content and the management of that content as described and illustrated below and it is in this context that the disclosure will be described. It will be appreciated, however, that the system and method has greater utility since it can be used to manage any type of digital content and may be implemented in different ways that those disclosed below. Thus, a system and method for generating, delivering, measuring, and managing media apps to showcase content, such as videos, documents, blogs, and slides, using a web-based portal are provided. The system allows the content to be uploaded to the portal, or generated from related collateral originally created for a webinar. The portal may include one or more different components for each type of content and these mechanisms generally require the content to be ready in a pre-digested format required by the platform, such as a video file, or a powerpoint deck, or a PDF file, or an article written in or pasted from a document editor for a blog post. The system also allows the content to be extracted from webinars in addition to being uploaded in its native, raw form.

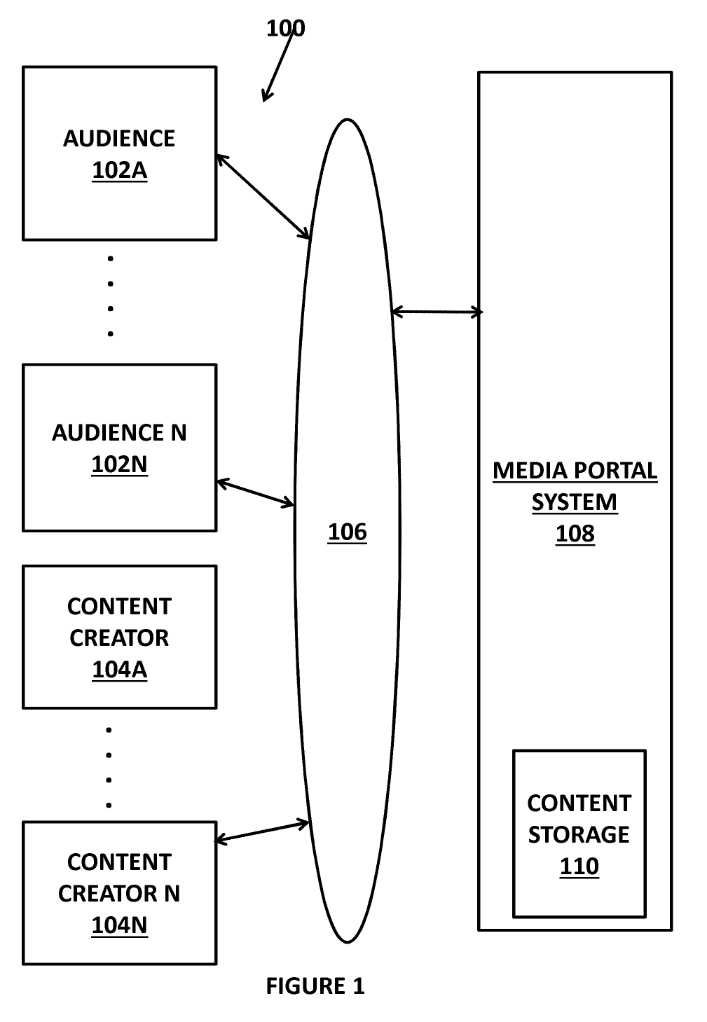

FIG. 1 illustrates an example of a content management system 100. The system may connect one or more audience members and one or more content creators and allow them to interact with each other to share/distribute various types of content as described below in more detail. In the system, the one or more audience members may consume one or more pieces of content that may be generated by the one or more content creators. In the system, each audience member may have a computing device 102, such as 102A, . . . , 102N, that the audience member uses to connect to and interact with a media portal system 108 over a communication path 106. Each computing device 102 may be a processor based device with memory, permanent storage, a display and communication circuitry so that the computing device can connect to the media portal system and exchange data with the media portal system 108 using known or yet to be developed data transfer protocols, like HTTP or HTTPS, and communication protocols, like TCP/IP, etc. For example, each computing device 102 may be a mobile device, a desktop device, a smartphone device, a tablet computer, a terminal and the like. In some embodiments, the processor of the computing device may execute a browser application and the browser application uses the well known HTML data protocol to exchange data between the audience computing device and the media portal device 108. In some embodiments, the processor of the computing device may execute a media app as described below. As described in more detail below, when each audience member clicks on a particular piece of content via the thumbnail or description shown from a user interface of the content system, an interactive “Media App” may be launched to display that particular type of content. The content managed by the system may include a video, a document, a blog-post, or a slide deck.

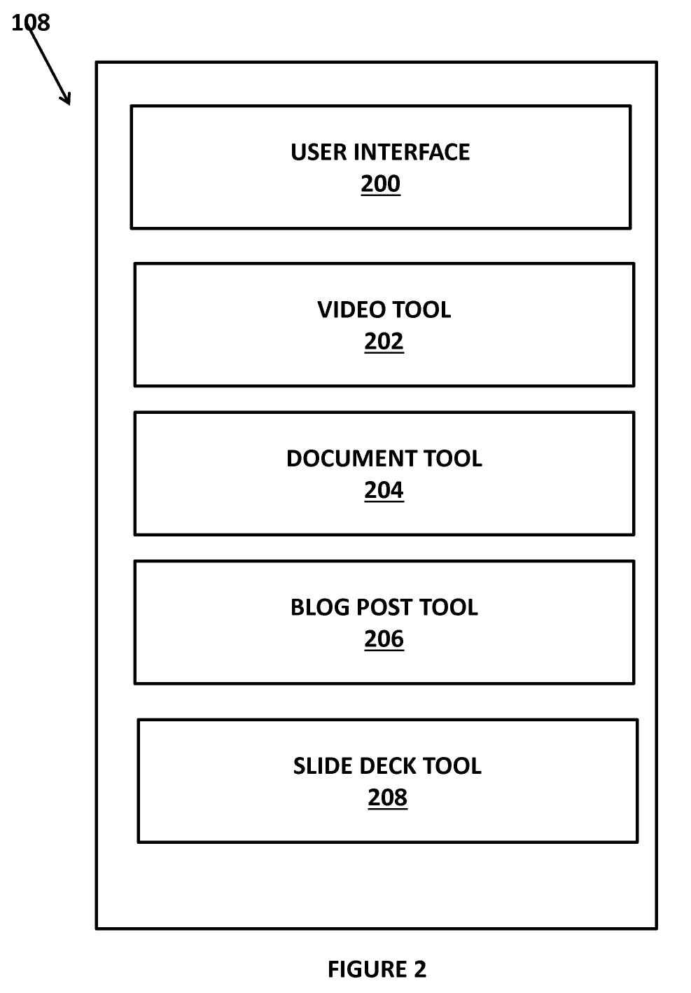

Each media app may be a plurality of lines of computer code (executed by a processor) or may be a hardware device that has the particular functionality. In some embodiments, the media app may be stored on the content system as shown in FIG. 2 and launched or stored on the content system, downloaded to the audience member computing device and executed by a processor of the audience member computing device. In some embodiments, each media app may be stored on the audience member computing device and executed by the processor of the audience member computing device. When the processor executed each media app, the processor is configured to perform the functions and operations of the media app as described below.

The system 100 may also include one or more content creator computing devices 104A, . . . , 104N that may be used by each content creator to connect to and interact with a media portal system 108 over a communication path 106. The content creator (using an app stored on the content system or using an app stored and executed locally on the content creator computing device) may have a tool to create new video from a webinar as described below in more detail. Furthermore, each content creator can also upload existing videos to the Video Library, from which it can be published to social media (like YouTube, Twitter, Facebook, etc.), or to the Portal.

Each computing device 104 may be a processor based device with memory, permanent storage, a display and communication circuitry so that the computing device can connect to the media portal system and exchange data with the media portal system 108 using known or yet to be developed data transfer protocols, like HTTP or HTTPS, and communication protocols, like TCP/IP, etc. For example, each computing device 104 may be a mobile device, a desktop device, a smartphone device, a tablet computer, a terminal and the like. In some embodiments, the processor of the computing device may execute a browser application and the browser application uses the well known HTML data protocol to exchange data between the audience computing device and the media portal device 108.

The media portal system 108 may be a plurality of computing resources that implement the media portal system or a plurality of hardware devices that implement the media portal system. The computing resources may be a server computer, a blade server, a cloud computing resource, an application server, a database server, processor(s), memory, a persistent storage device and the like. In an embodiment in which the media apps are stored on the media portal system 108, a content storage 110 associated with the media portal system 108 may store those media apps for later downloading to each computing device 102, 104 or for execution on the media system 108 for each computing device 102, 104. The content storage may also store the various content used by the system, user information and the like. The communication path 106 may be a wired or wireless data network (or a combination thereof) that use a particular data and transmission protocol, such as TCP/IP and HTTP or HTTPS. However, the system may be used with various communication paths 106.

The management component of the media portal system may perform various content related functions. For example, the management component of this application performs the following functions including:
Enable upload of media files (videos, documents, images)
Enable merging of media to create new forms of media—say, video with image, or with document, or multiple files—video+image+document, in any combination, to create an interactive online “highlights reel”
Enable publishing of media to social networks (e.g., youtube, twitter, linkedin, etc.)
Enable tagging of content into categories, for easy retrieval
Measure the value of media content—who watched it, for how long, and when.

FIG. 2 illustrates more details of the media portal system 108 in which the system has a plurality of media apps that may each be a plurality of lines of computer code or a hardware device. Each media app may receive a particular type of media content and provides various functions and tools as described below for content creator or audience member to interact with the piece of content media as described below. The media system 108 may also have a user interface component 200 (examples of the user interfaces generated by the system 108 are shown in various figures) that generates various user interfaces so that each audience member and each content creator can interact with the media portal system 108. For example, the media apps of the system may include a video tool 202 that allows manipulation of a video piece of content, a document tool 204 that allows manipulation of a document piece of content, a blog post tool 206 that allows manipulation of a blog post piece of content and a slide deck tool 208 that allows manipulation of a slide deck piece of content. Each of these media apps is extensible (more widgets can be added to the interface to add functionality), and each media app automatically measures engagement—what the user is doing while consuming the media. For example, who consumed that media, for how long, where did they spend more or less time, is tracked automatically, a set of features not available at your typical youtube, and immensely valuable to a markter trying to create a behavioral profile of a prospect to predict their likelihood for purchasing something.

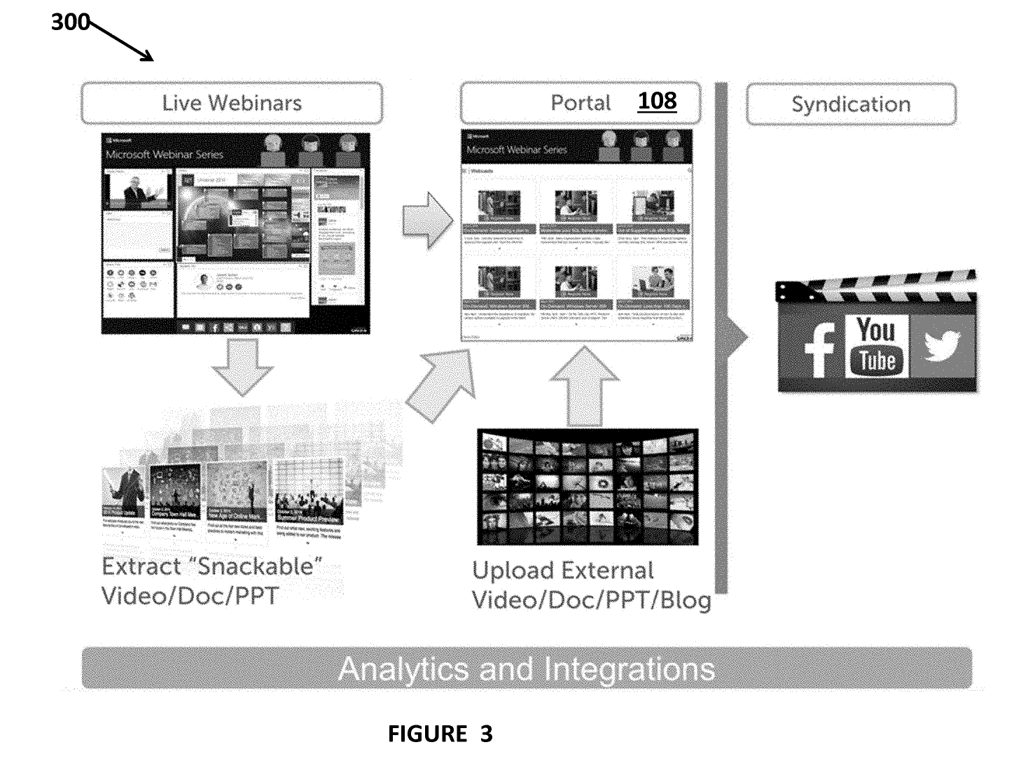

FIG. 3 illustrates a content system 300 that incorporates the media portal system 108. The content system may include live webinars and various content, using the media apps, may be extracted from the webinars including a video, a document and/or a powerpoint. In the system, each webinar may be automatically converted into a video recording. Using the system, the user can, using a browser, set the start and end marker above the video, extract and preview a clip. The system also allows this clip to be saved to a library for additional manipulation, downloaded, or distributed to portal or social media. The clipping process requires conversation with a back-end server for real-time extraction of video—a typical clip is extracted within 4-5 seconds rather than the minutes it typically takes to manipulate media files.

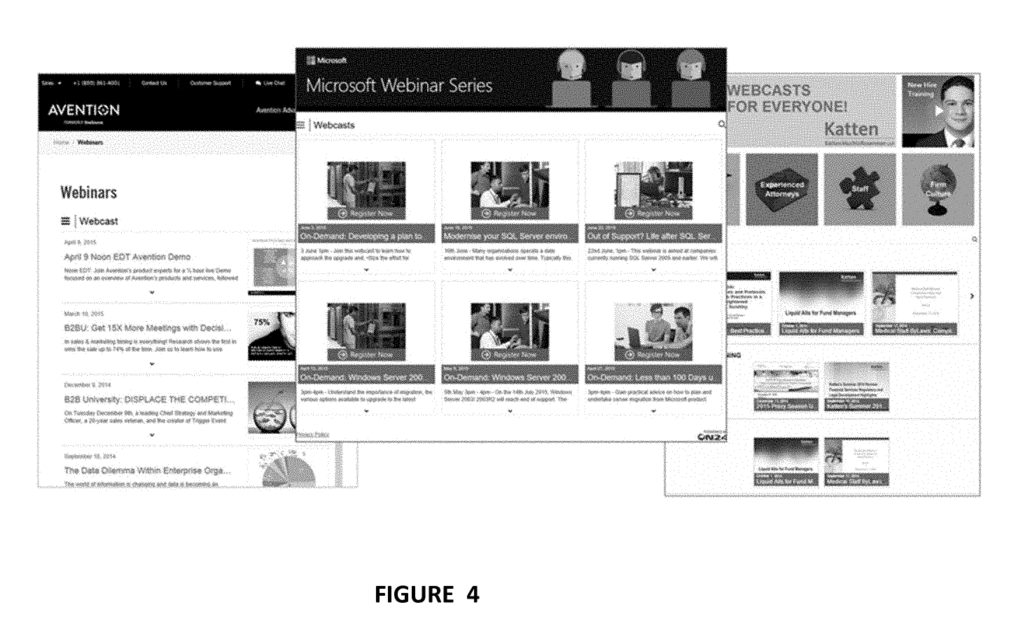

Those extracted pieces of content may be fed into the portal system 108. The portal system 108 may also receive/have uploaded pieces of content (video, document, powerpoint and/or blog) from external sources. The portal system 108 may provide the media app tools to manipulate the pieces of content and then the system 300 may syndicate the results through various syndication channels like Facebook, YouTube, Twitter and the like. FIG. 4 shows examples of the portal system that may be used to manipulate and distribute the various pieces of content using the media apps.

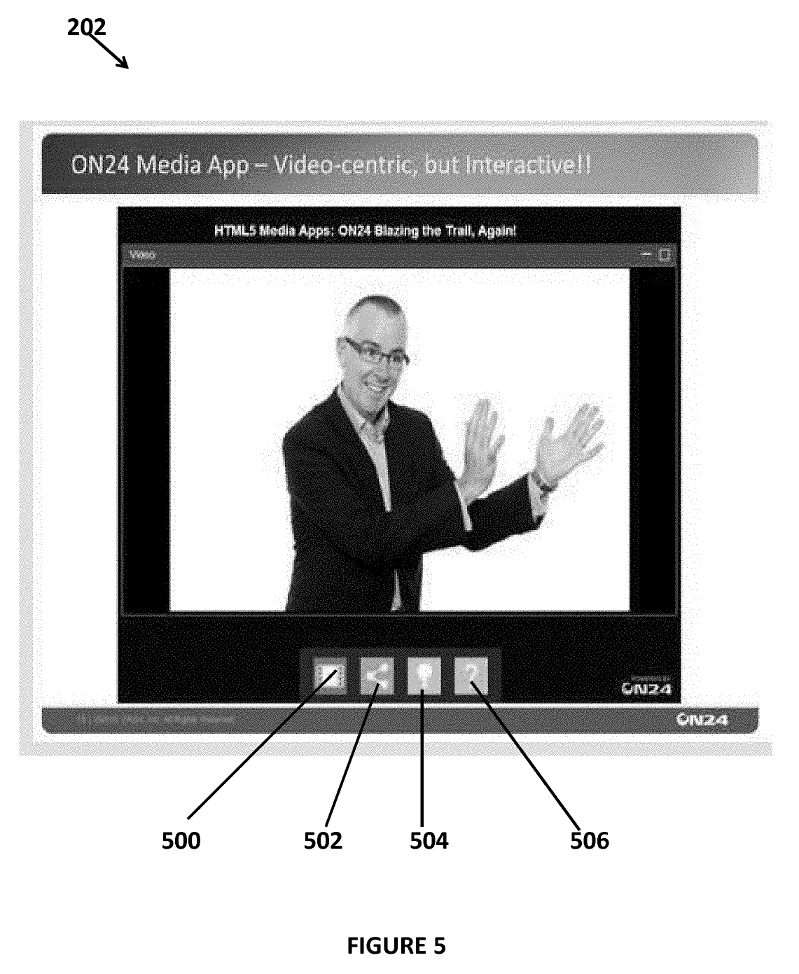

FIG. 5 illustrates an example of a video media app 202 of the media portal system in which the content creator may manipulate the video content and each audience member may view the video content. The media app may include a view video user interface element 500, a share video user interface element 502 and a help user interface element 504. The view video element 500 allows the user to view, start, stop, rewind, etc. the video and the share element 502 allows a user to share the video content with other users.

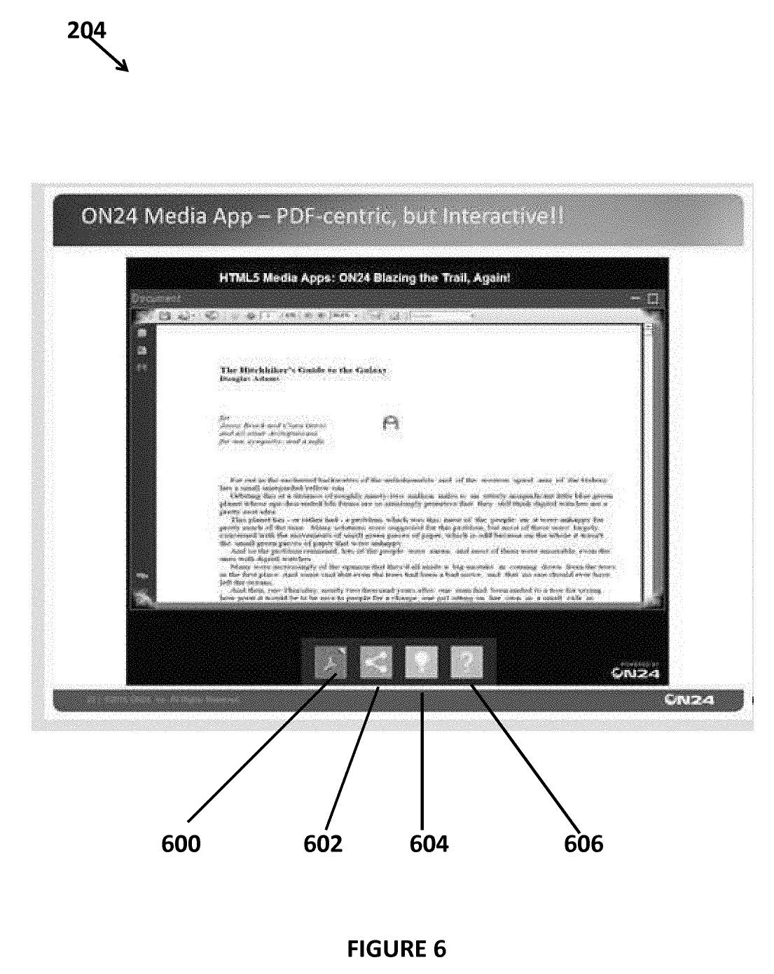

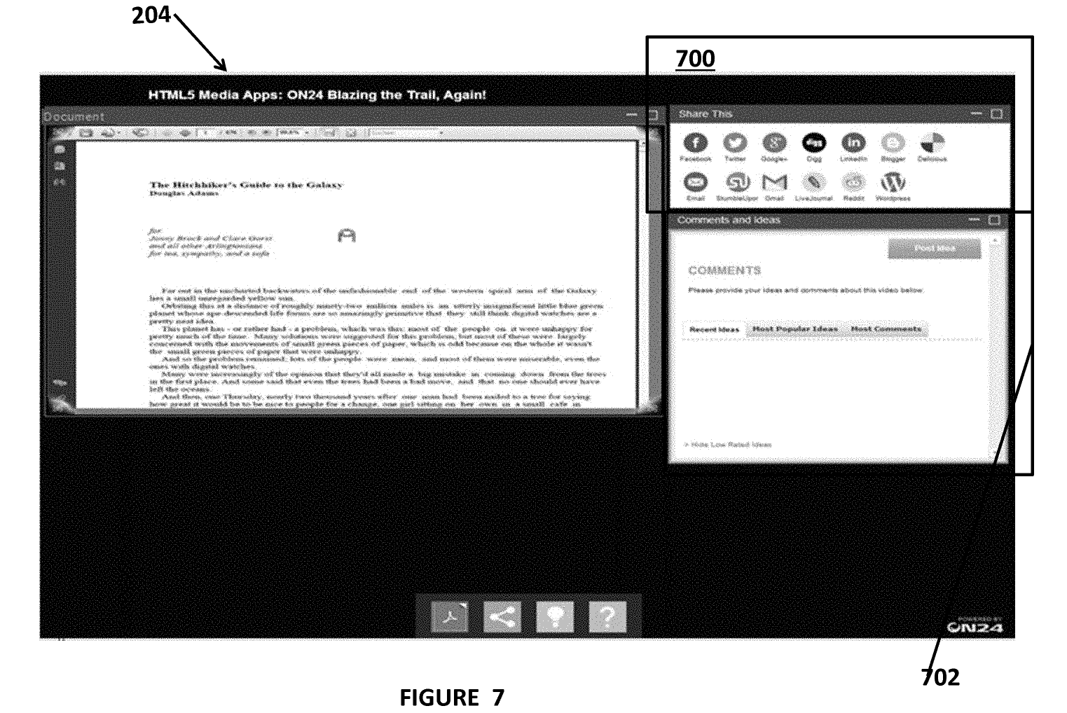

FIG. 6 illustrates an example of a document media app 204 of the media portal system in which the content creator may manipulate the document content and each audience member may view the document content. The media app may include a view document user interface element 600, a share document user interface element 602 and a help user interface element 606. The view document element 600 allows the user to view, start, stop, rewind, etc. the video and the share element 602 allows a user to share the video content with other users. In addition to the user interface elements shown in FIG. 6, each media app as shown in FIG. 7 may further include a sharing user interface element 700 that allows the user to choose the channel by which the user shares the content. Each media app also may have a comments user interface element 702 that permits the user to provide comments on the particular piece of content.

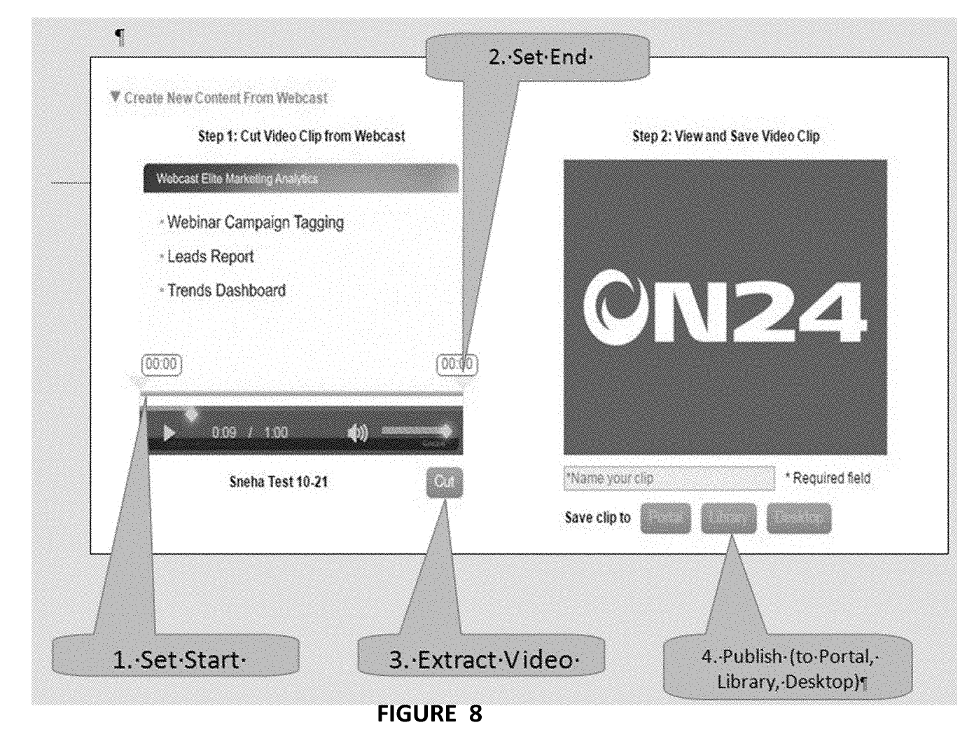

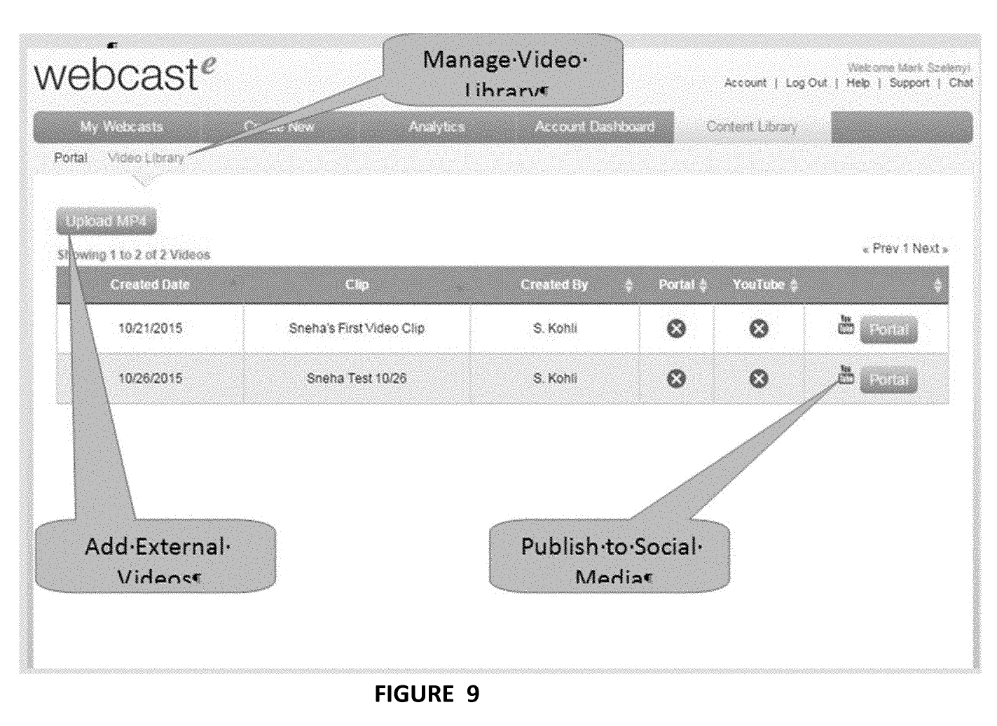

FIGS. 8-9 illustrate more details of the video media app that is part of the media portal system. As shown in FIGS. 8 and 9, the user interface permits a user to set a start time and an end time for a piece of video content and then to extract the video content using the “Cut” user interface element. The user interface may also permit the user to publish the video content to the media portal system, a library or a desktop. The user interface may also permit the user to view the video content. FIG. 9 is a user interface that allows the user to manage the pieces of content (video content in the example in FIG. 9) including adding an external video and then publishing the video content to a social media channel.

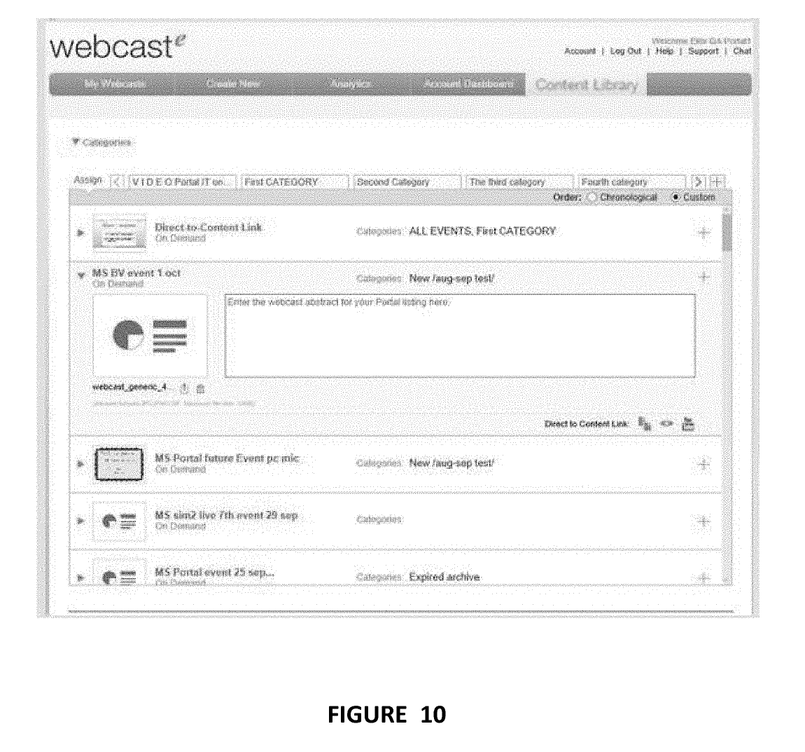

FIG. 10 illustrates a content management interface of the media portal system. Once content has been posted to the portal, such as the MS BV event 1 oct shown in FIG. 10, regardless of its type—video, slides, webinar, document, blog, can always be categorized and managed from a single, simple, centralized interface (an example of which is shown in FIG. 10) that allows tagging or categorization of the content for more targeted delivery and easy search as well as analytics and metrics.

An example of a piece of shared content may be a URL—so any URL, say to YouTube video, would be an example of the media content generated by this application and shared via Social Networks. The tagging/categorization adds those tags to the shared content on social networks, as hints that make the content more easily discoverable on those sites.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include and/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A method, comprising:
receiving a plurality of pieces of content, each piece of the plurality of different pieces of content having a different format;
managing, using a computer based media portal system, the plurality of received pieces of content, the media portal system having a plurality of media components wherein each media component is used to manage a piece of content having a particular format; and
wherein managing the plurality of received pieces of content further comprising using a particular media component of the computer based media portal system to manage each received piece of content having a particular format.

2. The method of claim 1, wherein managing the plurality of received pieces of content further comprises extracting a piece of content from a webinar.

3. The method of claim 2, wherein the extracted piece of content is one of a video, a document and a Powerpoint.

4. The method of claim 2, wherein managing the plurality of received pieces of content further comprises managing the piece of content extracted from the webinar.

5. The method of claim 1 further comprising reconfiguring at least one of the media components.

6. The method of claim 5, wherein reconfiguring at least one of the media components further comprises changing a behavior of the media component.

7. The method of claim 1, wherein the plurality of pieces of content are a video, a document, a blog post and a slide deck.

8. The method of claim 1, wherein managing the plurality of received pieces of content further comprises manipulating the piece of content using the media components.

9. The method of claim 1 further comprising tracking, using each media component, engagement of a user using the media component for the piece of media.

10. An apparatus, comprising:
a computer system having a processor and a memory;
a media portal executed by the processor and resident in the memory′
the media portal having a plurality of lines of code that are executed by the processor and the processor is configured to receive a plurality of pieces of content, each piece of the plurality of different pieces of content having a different format, manage the plurality of received pieces of content, the media portal system having a plurality of media components wherein each media component is used to manage a piece of content having a particular format and use a particular media component to manage each received piece of content having a particular format.

11. The apparatus of claim 10, wherein the processor is configured to extract a piece of content from a webinar.

12. The apparatus of claim 11, wherein the extracted piece of content is one of a video, a document and a Powerpoint.

13. The apparatus of claim 11, wherein the processor is configured to manage the piece of content extracted from the webinar.

14. The apparatus of claim 10, wherein the processor is configured to reconfigure at least one of the media components.

15. The apparatus of claim 14, wherein the processor is configured to change a behavior of the media component.

16. The apparatus of claim 10, wherein the plurality of pieces of content are a video, a document, a blog post and a slide deck.

17. The apparatus of claim 10, wherein the processor is configured to manipulate the piece of content using the media components.

18. The apparatus of claim 10, wherein the processor is configured to track, using each media component, engagement of a user using the media component for the piece of media.
